(19) United States
(12) Patent Application Publication
(10) Pub. No.: US 2012/0024252 A1
(43) Pub. Date: Feb. 2, 2012

(54) SYSTEM AND METHOD FOR STARTING AN ENGINE USING LOW ELECTRIC POWER

(75) Inventors: Jon C. Miller, Fenton, MI (US); Fernando F. Pio, Commerce Township, MI (US); Michael N. Kotsonas, Highland, MI (US); Mark D. Carr, Fenton, MI (US); Kevin A. Sherwin, Farmington Hills, MI (US)

(73) Assignee: GM GLOBAL TECHNOLOGY OPERATIONS, INC., Detroit, MI (US)

(21) Appl. No.: 12/844,992

(22) Filed: Jul. 28, 2010

(51) Int. Cl. F02N 11/08

(52) U.S. Cl. 123/179.3

(57) ABSTRACT

A method and a system are provided for starting an engine that is employed for propulsion of a vehicle. The method includes determining that an engine start via a starter is desired, wherein the starter is powered by an energy storage device. The method also includes determining a state of charge of the energy storage device. The method additionally includes commanding the starter to crank the engine at a first predetermined speed, if the energy storage device is at or above a predetermined state of charge and supplying fuel to the engine for a first predetermined number of fueling events. Furthermore, the method includes commanding the starter to crank the engine at a second predetermined speed that is lower than the first predetermined speed and supplying fuel to the engine for a second predetermined number of fueling events, if the energy storage device is below the predetermined state of charge.

### TECHNICAL FIELD

The invention relates to a system and method for starting an engine using low electric power.

### BACKGROUND

In a motor vehicle, the vehicle's engine, such as an internal combustion engine, is typically rotated via a starter to cause the engine to begin powering itself. Such a starter is typically powered electrically, and draws its power from an energy storage device arranged on-board the vehicle.

In some vehicle applications, a stop-start system is employed, where the engine is automatically stopped or shut off to conserve fuel when vehicle propulsion is not required, and is then automatically restarted by a starter when vehicle drive is again requested. Such a stop-start system may be employed in a conventional vehicle having a single powerplant, or in a hybrid vehicle application that includes both an internal combustion engine and a motor/generator for powering the vehicle.

### SUMMARY

A method is disclosed herein for starting an engine that is employed for propulsion of a vehicle. The method includes determining that an engine start via a starter is desired, wherein the starter is powered by an energy storage device that is arranged in the vehicle. The method also includes determining a state of charge of the energy storage device. The method additionally includes commanding the starter to crank the engine at a first predetermined speed, if the energy storage device is at or above a predetermined state of charge and supplying a fuel to the engine for a first predetermined number of fueling events. A state of charge of the energy storage device being at or above the predetermined state of charge signifies that the energy storage device is capable of providing a predetermined level of power. Furthermore, the method includes commanding the starter to crank the engine at a second predetermined speed that is lower than the first predetermined speed and supplying the fuel to the engine for a second predetermined number of fueling events, if the energy storage device is below the predetermined state of charge. A state of charge of the energy storage device being below the predetermined state of charge signifies that the energy storage device is incapable of providing the predetermined level of power.

According to the method, the acts of determining and commanding may each be accomplished via a controller in operative communication with each of the starter and the energy storage device. Additionally, according to the method the second predetermined number of fueling events may be greater than the first predetermined number of fueling events.

Additionally, the method may include determining a content of ethanol in the fuel. Furthermore, the method may include commanding the starter to crank the engine at the first predetermined speed, if the energy storage device is at or above the predetermined state of charge, whether the content of ethanol in the fuel is at, above, or below a predetermined level. Moreover, the method may include commanding the starter to crank the engine at the second predetermined speed, if the content of ethanol is at or above the predetermined level and the energy storage device is below the predetermined state of charge.

The engine may include a stop-start capability, and the vehicle may be a hybrid electric type that includes a motor/generator employed for propulsion of the vehicle.

A system for starting an engine employed for propulsion of a vehicle is also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a motor vehicle powertrain, including a system for starting an engine; and

FIG. 2 is a flow chart illustrating a method for starting an engine employed for propulsion of a vehicle.

### DETAILED DESCRIPTION

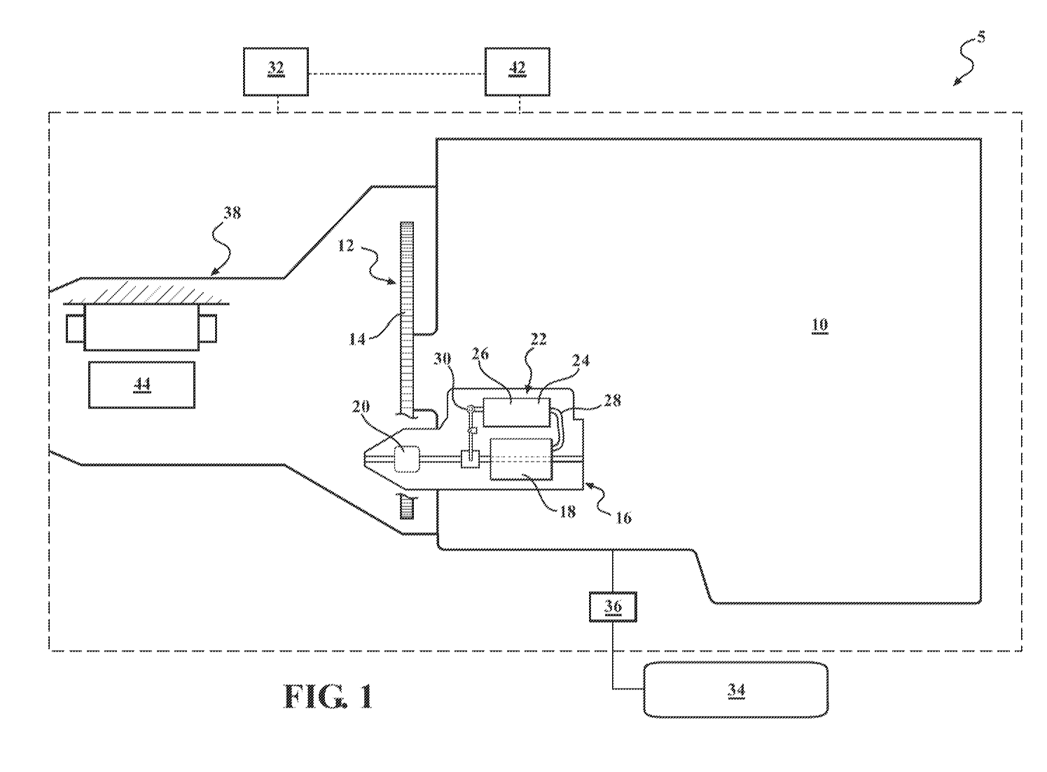

Referring to the drawings, wherein like reference numbers refer to like components, FIG. 1 shows a schematic view of an exemplary embodiment of a starter system 5, a.k.a. a system for starting an internal combustion engine 10. Starter system 5 includes engine 10 that is employed for propulsion of a vehicle. Engine 10 receives a supply of fuel in discrete fueling events, wherein such fuel is combined with air into a fuel-air mixture for subsequent ignition via a spark plug (not sown) to thereby generate combustion and produce power. Although, as illustrated, starter system 5 is employed in a hybrid-electric vehicle powertrain, the system may be used in any vehicle powertrain having engine 10.

Engine 10 includes a flywheel (or a flex-plate) 12 attached to a crankshaft (not shown) of the engine, and, as such, rotates at the same speed as the engine. Flywheel 12 is typically attached to the crankshaft via fasteners such as bolts or screws (not shown). A ring gear 14 having a specific gear tooth profile and spacing, is arranged on the outer perimeter of the flywheel 12. Ring gear 14 typically has an outer diameter that is designed to facilitate effective starting of engine 10, as understood by those skilled in the art. A starter 16 is arranged relative to the engine 10 in close proximity to the ring gear 14 for starting the engine. Starter 16 may be mounted directly on the engine to reduce the effect of manufacturing tolerances, as shown in FIG. 1.

Starter 16 includes an electric motor 18 that is employed to rotate a pinion gear 20. Pinion gear 20 includes a gear tooth profile and spacing that corresponds to that of the ring gear 14 for accurate meshing and engagement therewith. Starter 16 also includes a pinion engagement solenoid assembly 22, which incorporates a motor solenoid 24 and a pinion-shift solenoid 26. Electric motor 18 is activated by motor solenoid 24 via an electrical connection 28 or via a suitable lever arrangement (not shown), in order to rotate pinion gear 20 up to a predetermined speed. Pinion-shift solenoid 26 is configured to energize a lever arrangement 30. When energized by the pinion-shift solenoid 26, lever arrangement 30 in turn displaces pinion gear 20 for meshed engagement with the ring gear 14, in order to start engine 10.

An energy storage device 32, such as a battery, is arranged in the vehicle to selectively accept/store an electrical charge and, on demand, power various devices, including the starter 16. While being used for its intended purpose, energy storage device 32 may become depleted of its electrical charge, such that the energy storage device becomes incapable of providing a predetermined requisite level of power. With respect to starter 16, such a predetermined level of power is established based on the first predetermined cranking speed of engine 10 at which the engine may be started during a specific number of cranking revolutions. During the starting of engine 10, each engine cranking revolution is accompanied by a fueling event adapted to deliver an appropriate amount of fuel to the engine in order to affect the firing, combustion, and sustained rotation of the engine.

The first predetermined cranking speed necessary to fire and start the engine is typically determined empirically during testing and calibration of engine 10. In a situation when energy storage device 32 becomes depleted of its electrical charge, starter 16 may be incapable of cranking the engine 10 at the first predetermined cranking speed. In such a situation, the state of charge of the energy storage device 32 may only be sufficient to deliver sufficient power to the starter 16 to crank engine 10 at a second predetermined cranking speed that is lower than the first predetermined cranking speed. When engine 10 is cranked with the energy storage device 32 below its predetermined state of charge, the same number of engine revolutions as when the state of charge is higher may be insufficient to start the engine. Therefore, if the engine 10 needs to be started with energy storage device 32 below the predetermined state of charge, the speed of starter 16 will be lowered to the second predetermined cranking speed, while the number of fueling events may need to be increased.

Fuel is delivered to engine 10 from a fuel tank 34 via a fuel pump 36. Fuel pump 36 may be powered by the energy storage device 32 to operate engine 10 on demand. The energy content of a fuel being used to operate engine 10 influences how much of the particular fuel must be provided during each engine revolution cranked by starter 16. In particular, a content of ethanol in the fuel is a significant factor in starting engine 10, because ethanol contains approximately 34% less energy per unit volume than gasoline. Hence, when a fuel being used contains a significant percentage of ethanol, especially during low electric power engine starting conditions, the amount of fuel per each fueling event must be increased along with the number of engine revolutions generated by starter 16.

System 5 may be employed in any vehicle having an engine 10, but is particularly beneficial in a vehicle where engine 10 has a stop-start feature. As is known by those skilled in the art, a stop-start feature in an engine is where the engine is capable of being shut off when engine power is not required, but which may also be immediately restarted when engine power is again called upon to power the vehicle. As shown in FIG. 1, system 5 may also include a transmission 38 that is connected to engine 10 for transmitting engine power to drive wheels (not shown) of the subject vehicle. Transmission 38 includes an appropriate gear-train arrangement, which is not shown, but the existence of which will be appreciated by those skilled in the art. Arranged inside transmission 38 is a motor-generator 44. Motor-generator 44 is employed for propulsion of the subject vehicle either in concert with, or unaccompanied by engine 10. Engine 10 is capable of being shut off when the motor-generator 44 is running, such that the system 5 may be employed even while the subject vehicle is on the move.

A controller 42 is arranged on the vehicle relative to the engine 10 and transmission 38, and configured to control operation of both the engine and the transmission, including the shutting down and restarting of the engine during the stop-start procedure. Additionally, controller 42 is in operative communication with each of the starter 16 and the energy storage device 32. Controller 42 is programmed to activate starter 16 on demand to extend the pinion gear 20 and restart engine 10, based on predetermined vehicle operating parameters. The appropriate vehicle operating parameters may be predetermined empirically during calibration and testing phases of vehicle development, with the aim of optimizing performance, drivability and efficiency of the subject vehicle.

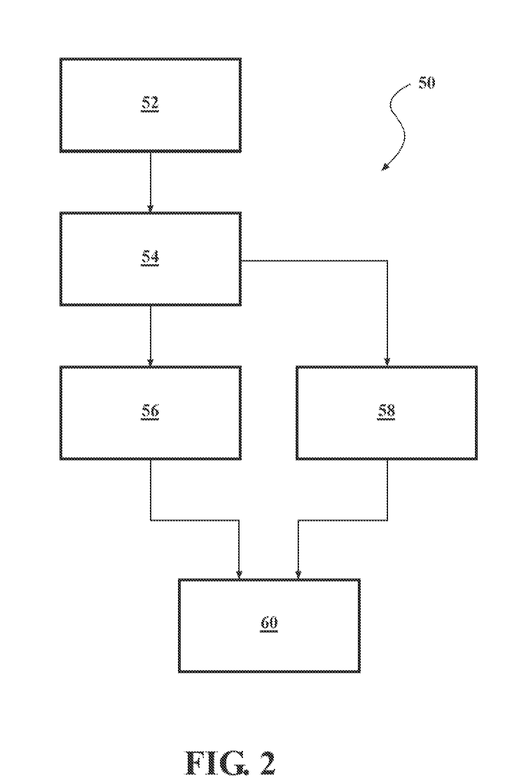

A method 50 for starting engine 10 employed for propulsion of a vehicle is shown in FIG. 2, and described below with reference to the structure shown in FIG. 1. Method 50 commences in frame 52 with determining that a start of engine 10 via starter 16 is desired. Such an engine start may be affected while the subject vehicle is either stationary or in motion, and is likewise applicable for either an ordinary engine start or for an engine restart during a stop-start maneuver. Following frame 52, the method proceeds to frame 54, where it includes determining a state of charge of the energy storage device 32.

If the state of charge of the energy storage device 32 determined in frame 54 is at or above the predetermined state of charge, and is thus capable of providing the predetermined level of power to starter 16, the method advances to frame 56. In frame 56, the method includes commanding starter 16 to automatically crank engine 10 by spinning flywheel 12 at the first predetermined speed. As described above, the first predetermined speed represents the engine speed required to crank, fire, and start engine 10 during the first predetermined number of fueling events. If the state of charge of the energy storage device 32 determined in frame 54 is below the predetermined state of charge, and is thus incapable of providing a predetermined level of power to starter 16, after frame 54 the method advances to frame 58.

In frame 58, the method includes commanding starter 16 to automatically crank engine 10 at the second predetermined speed that is lower than the first predetermined speed. As described above, the second predetermined speed represents the speed that may be used to crank, fire, and start engine 10 when accompanied by the second predetermined number of fueling events while the state of charge of energy storage device 32 is below the predetermined state of charge. Hence, notwithstanding the depleted state of charge of starter 16, by cranking engine 10 at the second predetermined speed, the method allows the engine to be started. The method will typically terminate in frame 60 upon the firing and starting of engine 10.

The method 50 may additionally include determining a content of ethanol in the fuel and regulating starter 16 to crank engine 10 at the first predetermined engine speed when energy storage device 32 is at or above the predetermined state of charge. In such a situation, starter 16 is employed to crank engine 10 at the first predetermined engine speed whether the content of ethanol in the fuel is at, above, or below a predetermined level. Furthermore, the method may then proceed with commanding starter 16 to automatically crank engine 10 at the second predetermined speed, if the content of ethanol is at or above the predetermined level and energy storage device 32 is below the predetermined state of charge.

The predetermined, i.e., threshold, content of ethanol in the fuel at and above which the ease of starting and firing of engine 10 is sufficiently affected is typically established empirically during testing and calibration of the engine. The second predetermined speed of starter 16 may be accompanied by the second predetermined number of fueling events which may be greater than the first number of fueling events in order to facilitate the firing and starting of engine 10. All of the above acts of determining and commanding may be accomplished by the controller 42 in order to provide the most effective starting of engine 10 despite a low power condition of energy storage device 32, and/or a high content of ethanol in the fuel supplied by fuel pump 36.

Overall, the number of revolutions and fueling events required to fuel, fire, and start engine 10 when the state of charge of energy storage device 32 is below the predetermined state of charge may need to increase when starter 16 operates at the second predetermined speed. Additionally, accompanying the reduced starter speed with an increased number of fueling events may become particularly advantageous when the content of ethanol in the fuel is sufficiently high so as to additionally negatively impact the starting of engine 10.

While the best modes for carrying out the invention have been described in detail, those familiar with the art to which this invention relates will recognize various alternative designs and embodiments for practicing the invention within the scope of the appended claims.

1. A method for starting an engine employed for propulsion of a vehicle, the method comprising:
determining that an engine start via a starter arranged relative to the engine is desired, wherein the starter is powered by an energy storage device;
determining a state of charge of the energy storage device;
commanding the starter to crank the engine at a first predetermined speed, if the energy storage device is at or above a predetermined state of charge and supplying a fuel to the engine for a first predetermined number of fueling events; and
commanding the starter to crank the engine at a second predetermined speed that is lower than the first predetermined speed and supplying the fuel to the engine for a second predetermined number of fueling events, if the energy storage device is below the predetermined state of charge.

2. The method of claim 1, wherein said determining and said commanding are each accomplished via a controller in operative communication with each of the starter and the energy storage device.

3. The method of claim 1, wherein the second predetermined number of fueling events is greater than the first predetermined number of fueling events.

4. The method of claim 3, further comprising:
determining a content of ethanol in the fuel; and
commanding the starter to crank the engine at the first predetermined speed, if the energy storage device is at or above the predetermined state of charge, whether the content of ethanol in the fuel is at, above, or below a predetermined level.

5. The method of claim 4, further comprising commanding the starter to crank the engine at the second predetermined speed, if the content of ethanol is at or above the predetermined level and the energy storage device is below the predetermined state of charge.

6. The method of claim 1, wherein the engine includes a stop-start capability.

7. The method of claim 6, wherein the vehicle is a hybrid electric type that includes a motor/generator employed for propulsion of the vehicle.

8. A system for starting an engine employed for propulsion of a vehicle, the system comprising:
a starter arranged relative to the engine;
an energy storage device arranged to power the starter;
a controller in operative communication with each of the starter and the energy storage device, and adapted to:
determine that an engine start via the starter is desired;
determine a state of charge of the energy storage device;
command the starter to crank the engine at a first predetermined speed, if the energy storage device is at or above a predetermined state of charge and supplying a fuel to the engine for a first predetermined number of fueling events; and
command the starter to crank the engine at a second predetermined speed that is lower than the first predetermined speed and supplying the fuel to the engine for a second predetermined number of fueling events, if the energy storage device is below the predetermined state of charge.

9. The system of claim 8, wherein the second predetermined number of fueling events is greater than the first predetermined number of fueling events.

10. The system of claim 9, wherein the controller is additionally adapted to:
determine a content of ethanol in the fuel; and
command the starter to crank the engine at the first predetermined speed, if the energy storage device is at or above the predetermined state of charge, whether the content of ethanol in the fuel is at, above, or below a predetermined level.

11. The system of claim 10, wherein the controller is additionally adapted to command the starter to crank the engine at the second predetermined speed, if the content of ethanol is at or above the predetermined level and the energy storage device is below the predetermined state of charge.

12. The system of claim 8, wherein the engine includes a stop-start capability.

13. The system of claim 12, wherein the vehicle is a hybrid electric type that includes a motor/generator employed for propulsion of the vehicle.
